(19) United States
(12) Patent Application Publication
(10) Pub. No.: US 2026/0253007 A1
(43) Pub. Date: Aug. 27, 2026

(54) METHOD AND SYSTEM FOR IMPLEMENTING A FRAMEWORK FOR RISK-BASED INSPECTION (RBI) METHODOLOGIES

(71) Applicant: AsInt, Inc., Pearland, TX (US)

(72) Inventors: Rohan Patel, Pearland, TX (US); Jarret Reeves, Pearland, PA (US); Michael Warren, Pearland, TX (US)

(21) Appl. No.: 19/060,655

(22) Filed: Feb. 22, 2025

(51) Int. Cl. G06Q 10/0635; G06Q 10/20

(52) U.S. Cl. CPC G06Q 10/0635; G06Q 10/20

(57) ABSTRACT

The present disclosure provides a system and method for implementing a framework for Risk-Based Inspection (RBI) methodologies to address the need for efficient asset risk assessment and management in industries such as oil and gas, petrochemical, chemical, specialty chemical, power generation, utilities, pipeline, hi-tech industries, pharmaceutical, and manufacturing. The system analyses asset parameters, including specifications, historical data, and real-time performance metrics, to determine the probability of failure (PoF) and consequence of failure (CoF). Risk levels are calculated by combining PoF and CoF, allowing for the identification and prioritization of high-risk assets. In addition, real-time data updates refine risk assessments, enabling dynamic adjustments to inspection strategies. This framework generates optimized inspection recommendations and maintenance schedules, improving asset reliability, safety, and operational efficiency.

### TECHNICAL FIELD

The present disclosure relates to the field of industrial asset management and maintenance. In particular, the present disclosure provides a system and a method for implementing Risk-Based Inspection (RBI) methodologies to assess, prioritize, and manage maintenance and inspection of assets to enhance risk evaluation.

### BACKGROUND

Risk-Based Inspection (RBI) has become an essential methodology in industries such as oil and gas, chemical, and manufacturing, enabling organizations to optimize their inspection and maintenance activities by evaluating the risk of equipment failure. The primary objective of RBI is to prioritize resources and reduce downtime by focusing on assets most at risk of failure. The American Petroleum Institute (API) provides two key standards to guide the RBI process: API RP 580 and API RP 581. API RP 580 offers general recommendations for implementing RBI, while API RP 581 provides detailed quantitative methods for calculating two key factors: Probability of Failure (PoF) and Consequence of Failure (CoF). These standards serve as the foundation for developing risk models in many industries.

While existing RBI methods are well-established and widely adopted, they come with significant challenges. One of the major difficulties is the complexity and resource-intensive nature of the calculations, particularly for determining CoF, which can often become a bottleneck in organizations attempting to implement RBI. CoF assessments require extensive data analysis and can involve numerous variables, making the process slow and difficult to manage, especially when organizations are dealing with large volumes of equipment and assets.

Existing RBI techniques also have drawbacks related to their limited flexibility in accommodating different global regulatory frameworks. While standards like API RP 580 and RP 581 are comprehensive, they are often tailored to specific regions or regulatory environments, leaving companies with the challenge of aligning their risk models across multiple jurisdictions. Furthermore, traditional RBI methodologies typically do not integrate digital transformation tools effectively.

Many techniques have been developed to address the challenges mentioned above. For instance, a patent document, U.S. Pat. No. 12,105,579, discloses a system and method for automatically predicting and detecting the failure of a system or component. This approach includes one or more data sources, a data pipeline interface communicably coupled to the data sources, processors that interact with the data pipeline and relational databases, and devices that provide the options and impact or implement these options. The data pipeline interface processes and stores data in relational databases while processors quantify, forecast, and prognosticate the likelihood of future events using predictive modules. They then determine options and impacts using a prescriptive module, with the devices carrying out the necessary actions. While this prior art provides a predictive approach, it does not disclose an integrated and simplified model for assessing the Consequence of Failure (CoF) specifically within the context of Risk-Based Inspection (RBI).

Another patent document, U.S. Pat. No. 11,416,326, discloses a computer-implemented method for failure diagnosis using a fault tree analysis. The method includes receiving a fault tree with nodes representing a top event and basic events, obtaining reliability parameters, calculating fault tree importance measures, and determining failure impact factors for the top event. It ranks the basic events based on their failure impact factors and identifies the most significant contributor to the top event. This method calculates the failure probability of the system by evaluating the reliability of each basic event and its contribution to failure. However, while this prior art focuses on failure diagnosis and prioritization of failure events, it fails to integrate a comprehensive, simplified approach for assessing the Consequence of Failure (CoF) in the context of Risk-Based Inspection (RBI). Furthermore, it does not address need for dynamic risk modeling that incorporates real-time data analytics or the ability to accommodate multiple regulatory frameworks in a unified, adaptable model.

Therefore, there is a need for a system and a method to implement Risk-Based Inspection (RBI) methodologies that streamline risk evaluation, prioritize asset maintenance and inspection, and enhance the management of industrial assets efficiently.

### SUMMARY

The present disclosure relates to the field of industrial asset management and maintenance. In particular, the present disclosure provides a system and a method for implementing Risk-Based Inspection (RBI) methodologies to assess, prioritize, and manage maintenance and inspection of assets. In addition, the system and the method utilize advanced modeling techniques to enhance risk evaluation and optimize maintenance schedules for improved operational efficiency and safety.

An aspect of the present disclosure pertains to a method for implementing a framework for Risk-Based Inspection (RBI) methodologies. The method includes receiving a set of parameters of one or more assets from an enterprise resource planning (ERP) system, and the received data include at least one of: asset specifications, historical inspection data, and real-time performance metrics. The method also includes determining probability of failure (PoF) for each asset taking into consideration the received parameters, and considering one or more factors of each asset comprising condition, usage history, and environmental conditions. The method also includes evaluating consequence of failure (CoF) by assessing interaction between the operational data and the determined PoF and evaluating impact of failure using various approaches, for example Loss of Containment (LoC) or Loss of Production (LoP) (also known as a fluid modeling technique). The method also includes calculating risk levels for each asset from the determined PoF and the evaluated CoF to quantify risk associated with each asset. Further, the method includes plotting the calculated risk levels on a risk prioritization matrix to visually represent and identify the high-risk assets and correspondingly prioritize each asset for maintenance. Furthermore, the method includes refining the PoF, using updated real-time data, updating the risk levels and adjusting prioritization of the assets in the risk prioritization matrix based on the refined PoF, and generating recommendations and maintenance schedules based on the updated risk levels and the adjusted prioritization of the one or more assets. A system may include a memory having the method for implementing the framework for RBI methodologies stored as processor-executable instructions and a processor that executes the processor-executable instructions in the memory.

In some embodiments, the set of parameters for each asset is extracted from a master data stored in the ERP system. In addition, a SAP Business Technology Platform (BTP) is utilized to process and integrate the master data into the framework.

In some embodiments, the Loss of Containment (“LoC”) or Loss of Production (LoP) (also known as a fluid modeling technique) evaluates the CoF that complies with one or more predefined standards.

In some embodiments, the risk prioritization matrix is a two-dimensional matrix that maps the determined PoF and the evaluated CoF for each asset to identify the high-risk assets in predefined regions of the risk prioritization matrix for prioritization.

In some embodiments, the method further includes calculating a degradation rate for each asset based on the historical inspection data, and the real-time performance metrics. The degradation rate is utilized for adjusting the generated maintenance schedules and recommend inspection intervals.

In some embodiments, the method further includes receiving one or more environmental factors from the ERP system, and the environmental factors are selected from a group comprising temperature, humidity, external load, exposure to corrosive substances, and wherein the one or more environmental factors are incorporated in the determination of the PoF for each asset.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an example representation of a network environment implementing a system to implement a framework for Risk-Based Inspection (RBI) methodologies, according to embodiments of the present disclosure.

FIG. 2 illustrates an example block diagram of the system according to embodiments of the present disclosure.

FIG. 3 illustrates a flowchart of an example method for implementing a framework for RBI methodologies according to embodiments of the present disclosure.

FIG. 4 illustrates a flowchart of an exemplary implementation of proposed method, according to embodiments of the present disclosure.

FIG. 5 illustrates an example computer system in which or with which embodiments of the system may be implemented, according to embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

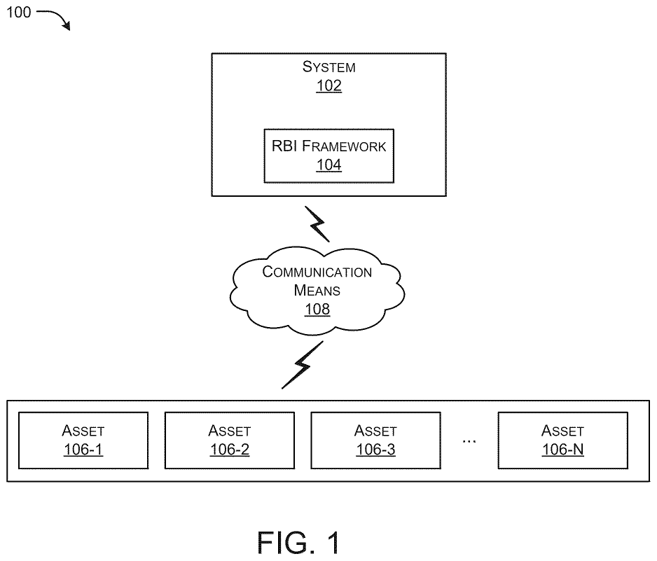

Embodiments explained herein relate to the field of industrial asset management and maintenance. In particular, the present disclosure provides a system and a method for implementing Risk-Based Inspection (RBI) methodologies to assess, prioritize, and manage maintenance and inspection of assets to enhance risk evaluation. Various embodiments of the present disclosure will be explained in detail with reference to FIGS. 1-5.

FIG. 1 illustrates an example network environment/architecture 100. The network environment 100 may also include or be associated with a system 102 to implement a framework 104 for Risk-Based Inspection (RBI) methodologies (interchangeably referred to as RBI framework 104, hereinafter) to assess, prioritize, and manage maintenance and inspection of assets 106 to enhance risk evaluation. The RBI framework 104 integrates several industry-leading risk assessment models within the SAP ecosystem, providing scalability, accuracy, and adaptability across diverse industrial settings. In addition, RBI framework 104 incorporates models like API RP 581, Condition-Based PRDs, and international regulatory frameworks like the European PED and Brazilian NR-13 standards. Each model contributes to improving asset management and optimizing maintenance schedules in line with global best practices.

In some embodiments, an EN 16991 Risk-Based Inspection Framework (RBIF) may be utilized to enhance adaptability across multiple industries such as hydrocarbons, chemicals, and power generation. This RBIF supports both Risk-Based Inspection (RBI) and Risk-Based Maintenance (RBIM), ensuring that maintenance activities are optimized and asset integrity is maintained. By incorporating EN 16991, the RBI framework 104 ensures compliance with proven industry standards while improving operational efficiency.

In some embodiments, the RBI framework 104 integrates international regulatory models like a European Pressure Equipment Directive (PED) 2014/68/EU and Brazilian NR-13 standards. These risk models enable organizations to comply with both European and Brazilian regulatory frameworks while maintaining the efficiency and effectiveness of their RBI approach. This makes the RBI framework 104 suitable for multinational operations that require compliance with local and global standards.

In some embodiments, the RBI framework 104 has seamless integration with the SAP Business Technology Platform (BTP) and is natively built within a SAP ecosystem, integrating effortlessly with backend SAP ERP systems. This integration allows for the utilization of both master and transactional data, enabling real-time analytics and predictive insights. With this connection, the RBI framework 104 ensures that risk assessments are continuously updated based on the most current operational data. This dynamic updating enhances decision-making, allowing operators to prioritize maintenance activities and interventions based on real-time risk levels, improving asset management and operational efficiency.

These assets 106 are physical components or equipment, such as pipes, tanks, valves, machinery, or other essential infrastructure that require regular inspection and maintenance. The assets 106 are monitored, controlled, and managed through communication means 106. At least one of the assets 106 may be operated by an entity.

The assets 106 are connected to a centralized control system or network through communication means 108. This communication means 108 enables the transfer of data between the assets 106 and the monitoring or management systems. The communication can be facilitated through both wired and wireless technologies, Examples of wired communication means may include, but not be limited to, electrical wires/cables, optical fibre cables, and the like. Examples of wireless communication means may include any wireless communication network capable of transferring data using means including, but not limited to, radio communication, satellite communication, a Bluetooth, a Zigbee, a Near Field Communication (NFC), a Wireless-Fidelity (Wi-Fi) network, a Light Fidelity (Li-Fi) network, a carrier network including a circuit-switched network, a packet switched network, a Public Switched Telephone Network (PSTN), a Content Delivery Network (CDN) network, an Internet, intranets, Local Area Networks (LANs), Wide Area Networks (WANs), mobile communication networks including a Second Generation (2G), a Third Generation (3G), a Fourth Generation (4G), a Fifth Generation (5G), a Sixth Generation (6G), a Long-Term Evolution (LTE) network, a New Radio (NR), a Narrow-Band (NB), an Internet of Things (IoT) network, a Global System for Mobile Communications (GSM) network and a Universal Mobile Telecommunications System (UMTS) network, combinations thereof, and the like.

The assets 106 may be operated by corresponding entities. In some embodiments, the entity may be a human entity for managing or operating these assets. The human entities may be involved in tasks such as conducting inspections, performing maintenance, or overseeing the operation of machinery. Additionally, automated systems or entities can interact with the assets 106 by sending control signals or instructions, which may trigger specific actions such as equipment operation or data collection. For example, an automated control system could manage equipment while human operators may monitor or intervene as needed for inspection or maintenance tasks.

The system 102 implements a comprehensive framework for Risk-Based Inspection (RBI) methodologies to assess and prioritize asset risks based on various parameters. The system 102 receives asset specifications, historical inspection data, and real-time performance metrics from an ERP system to determine the Probability of Failure (PoF) while accounting for factors such as condition, usage history, and environmental conditions. Using a fluid modeling technique such as Loss of Containment (LoC) or Loss of Production (LoP) approach, it evaluates the Consequence of Failure (CoF) and calculates risk levels, which are visually represented on a two-dimensional risk prioritization matrix. This matrix helps identify high-risk assets 106 for prioritization. The system 102 continuously refines PoF by integrating updated real-time data, recalibrating risk levels, and generating dynamic inspection recommendations and maintenance schedules. The system 102 further calculates degradation rates to optimize inspection intervals and incorporates environmental factors such as temperature, humidity, and corrosive exposure into the risk evaluation process.

While FIG. 1 shows few components of the network environment 100, it may be appreciated by those skilled in the art that the network environment 100 may be suitably adapted to include other components or elements not explicitly shown in FIG. 1.

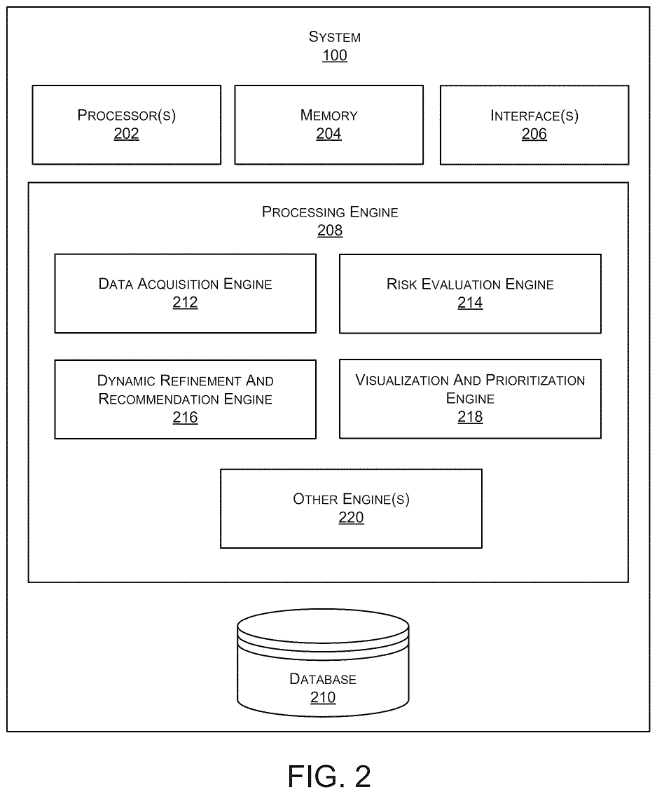

The system 102 may include a plurality of components that enable the aforementioned operations to be performed. In some embodiments, the system 102 may be implemented in a hardware, or a suitable combination of hardware and software. Further, the system 102 may include one or more processors 202, Input/Output (I/O) interface(s) 206, and a memory 204, as illustrated and described in reference to FIG. 2. Further, the system 102 may also include other units such as a display unit, an input unit, an output unit, and the like, however the same are not shown in FIG. 2, for the purpose of clarity.

In some embodiments, the system 102 may be a hardware device including the processors 202. The processors 202 may be configured to execute machine-readable program instructions. Execution of the machine-readable program instructions by the processors 202 may enable the proposed system 102 to manage the cybersecurity risks of the network environment 100. The “hardware” may include a combination of discrete components, microprocessors, microcomputers, microcontrollers, digital signal processors, central processing units, state machines, logic circuits, an integrated circuit, an application-specific integrated circuit, a field programmable gate array, a digital signal processor, or other suitable hardware that manipulate data or signals based on operational instructions. The “software” may include one or more objects, agents, threads, lines of code, subroutines, separate software applications, or other suitable software structures operating in one or more software applications or on one or more processors. Among other capabilities, the processor 202 may fetch and execute machine-readable/processor-executable instructions in the memory 204 operationally coupled with the system 102 for performing tasks such as data processing, input/output processing, feature extraction, and/or any other functions. Any reference to a task in the present disclosure may refer to an operation being or that may be performed on data.

The memory 204 may store one or more machine-readable/processor-executable instructions or routines, which may be fetched and executed to create or share the data units over a network service. In some embodiments, the memory 204 may include any non-transitory storage device including, for example, volatile memory such as Random Access Memory (RAM), or non-volatile memory such as an Erasable Programmable Read-Only Memory (EPROM), flash memory, and the like.

The I/O interface(s) 206 may facilitate communication between the system 102, and the assets 106 of the network environment 100. The interface(s) 206 may also provide a communication pathway for one or more components of the system 102. Examples of such components include, but are not limited to, processing engine(s) 208 and database 210.

The database 210 may include data that is either stored or generated as a result of functionalities implemented by any of the components of the processing engine(s) 208. For example, the database 210 may store the asset weights, and other values and data structures resulting from the operation of the processors 202.

In an embodiment, the processing engine(s) 208 may be implemented as a combination of hardware and software (for example, programmable instructions) to implement one or more functionalities of the processing engine(s) 208. For example, the programming for the processing engine(s) 208 may be processor-executable instructions stored on a non-transitory machine-readable storage medium, and the hardware for the processing engine(s) 208 may include a processing resource (for example, one or more processors), to execute such instructions. Examples of the processing engine(s) 208 may include a data acquisition engine 212, a risk evaluation engine 214, a dynamic refinement and recommendation engine 216, a visualization and prioritization engine 218, and other engine(s) 220. The other engine(s) 220 may implement functionalities that supplement applications/functions performed by the system 102. Each of the processing engine(s) 208 may be configured to perform at least one task of the system 102.

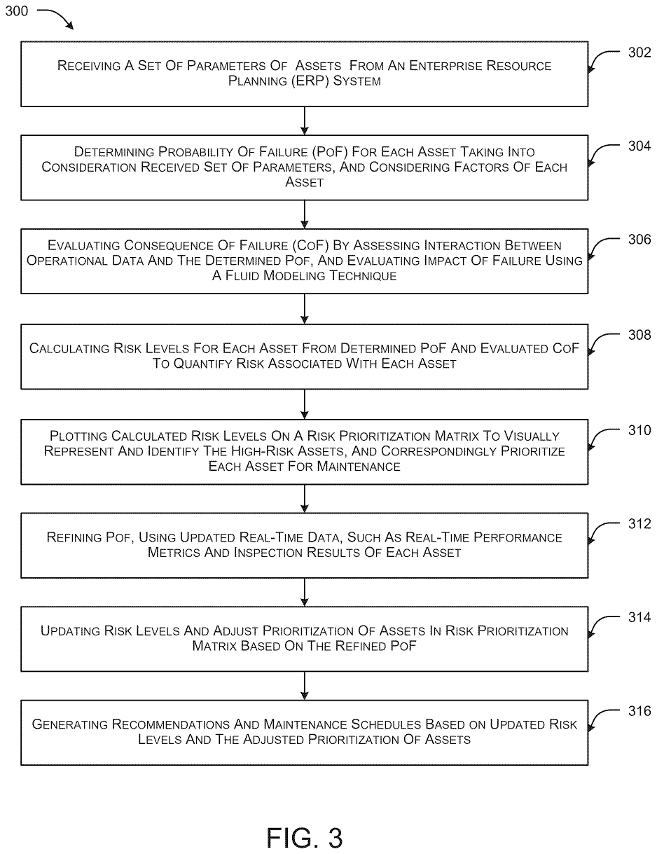

In some embodiments, the system 102 may be configured to implement the method 300 shown in FIG. 3.

FIG. 3 illustrates a flowchart of an example method 300 for implementing a framework for RBI methodologies, according to embodiments of the present disclosure. The method 300 may also be implemented by the system 102.

At step 302, the method 300 includes receiving, such as by the processor 202 of the system 102, a set of parameters of one or more assets 106 from an enterprise resource planning (ERP) system. The received set of parameters includes at least one of: asset specifications (e.g., model, capacity), historical inspection data (e.g., previous maintenance records), and real-time performance metrics (e.g., operational data from sensors). These set of parameters for each asset are extracted from master data stored in the ERP system, which serves as the centralized repository for all asset-related information. A SAP Business Technology Platform (BTP) is utilized to process and integrate the master data into the RBI framework 104, ensuring that accurate, up-to-date information is available for the analysis of risk and asset conditions.

In some embodiments, the method 300 may also integrate data and guidelines from API 580—Risk-Based Inspection (RBI), which provides guidelines for developing a Risk-Based Inspection program. This standard is essential for systematically identifying, assessing, and mitigating risks related to fixed equipment, such as pressure vessels, piping, and tanks. By utilizing API 580, the RBI framework can prioritize inspections based on risk, calculated through the evaluation of failure likelihood and consequences.

At step 304, the method 300 includes determining probability of failure (PoF) for each asset taking into consideration the received set of parameters, and considering one or more factors of each asset comprising condition (e.g., wear and tear, corrosion), usage history (e.g., operational hours, load), and environmental conditions (e.g., temperature, humidity, exposure to chemicals). The integration of these factors helps ensure that the PoF calculation is as accurate as possible, reflecting both current state and operational context. These insights guide asset owners in understanding which assets 106 are more likely to fail, allowing for more informed decision-making regarding maintenance and replacement schedules.

At step 306, the method 300 includes evaluating consequence of failure (CoF) by assessing interaction between the operational data and the determined PoF. In addition, this step evaluates impact of failure using various approaches, for example Loss of Containment (LoC) or Loss of Production (LoP) (also known as a fluid modeling technique) which could affect safety, production, environmental compliance, or operational costs. The fluid modeling technique is utilised to simulate impact of the failure under real-world conditions. This technique ensures that the CoF adheres to predefined standards (e.g., NFPA standards for fluid modeling) and is applied consistently across all assets. This evaluation ensures that assets 106 with high PoF and significant consequences are prioritized for inspection and maintenance.

In some embodiments, an API RP 581 Risk Calculator, based on 3rd Edition (April 2016) of API RP 581, is a key component of this adaptable RBI framework 104. This supports the PoF calculations as per API standards, ensuring precise risk assessments in line with established industry protocols. This RBI framework 104 also utilizes the simplified Consequence of Failure (CoF) calculation based on NFPA standards. This simplified approach offers a more efficient alternative while retaining the core accuracy of the original model, ensuring that the PoF and the CoF are accurately evaluated to provide a comprehensive risk profile for each asset.

In some embodiments, the method 300 utilizes API 581—Risk-Based Inspection Methodology, which provides a detailed, quantitative framework for implementing the RBI. This methodology includes specific formulas and methodologies for calculating the PoF, based on data such as corrosion rates, material properties, and operational conditions. API 581 works alongside API 580 to help optimize inspection intervals and strategies by using quantitative risk assessment models to estimate failure probabilities.

At step 308, the method 300 includes calculating risk levels for each asset from the determined PoF and the evaluated CoF to quantify risk associated with each asset. For instance, risk is a product of the PoF and the CoF, where the likelihood of failure is combined with severity of its potential impact. By multiplying these two factors, the method generates a quantitative risk value for each asset, representing risk associated with failure of asset. This calculation allows asset owners to assess which assets 106 pose the greatest risk to the operation, safety, and financial stability of the organization.

At step 310, the method 300 includes plotting the calculated risk levels on a risk prioritization matrix to visually represent and identify the high-risk assets and correspondingly prioritize each asset for maintenance. The risk prioritization matrix is a two-dimensional matrix that maps the determined PoF and the evaluated CoF for each asset to identify the high-risk assets 106 in predefined regions of the risk prioritization matrix for prioritization. For instance, the assets 106 are categorized into predefined risk zones (e.g., low, medium, high) on the risk prioritization matrix, allowing for quick identification of which assets 106 present the highest risk. The assets 106 that fall into the high-risk zone are given priority for immediate maintenance or inspection. The risk prioritization matrix thus acts as a decision-support tool, enabling asset managers to focus resources where they are most needed and optimize maintenance efforts.

At step 312, the method 300 includes refining the PoF, using updated real-time data, such as real-time performance metrics and inspection results of each asset. As the assets 106 continue to operate, new data such as real-time performance metrics and recent inspection results become available. This updated data provides a more accurate and current assessment of the asset's condition, allowing for adjustments to the PoF values. For instance, by incorporating this real-time data into the risk assessment process, the method 300 can provide a dynamic and evolving risk profile for each asset, ensuring that the risk assessment reflects the latest operational realities.

At step 314, the method 300 includes updating the risk levels and adjusting prioritization of the one or more assets 106 in the risk prioritization matrix based on the refined PoF. This ensures that any changes in asset condition, as reflected by the updated PoF, are incorporated into the risk prioritization process. For example, if the condition of an asset has worsened, causing an increase in the associated PoF, the risk level can be adjusted upward, moving this asset into a higher-priority zone on the risk matrix. This ensures that the most essential assets 106 are always prioritized for maintenance, optimizing asset reliability and minimizing unplanned downtime.

At step 316, the method 300 includes generating inspection recommendations and maintenance schedules based on the updated risk levels and the adjusted prioritization of the assets. This generates a customized maintenance plan based on the current risk assessment, identifying which assets 106 require immediate inspection, testing, or repair. This ensures that high-risk assets 106 are addressed promptly, reducing the likelihood of failures and improving asset integrity. Additionally, by considering latest data on asset performance and risk levels, the method 300 can optimize timing and scope of inspections, reducing unnecessary maintenance activities and associated costs.

Continuing further, the method 300 includes the step of calculating a degradation rate for each asset based on the historical inspection data and the real-time performance metrics. The historical inspection data provides information about the past condition and performance of the asset, while real-time performance metrics offer current operational insights. This calculated degradation rate is then used to adjust maintenance schedules and recommend appropriate inspection intervals, ensuring that maintenance activities are better aligned with the actual condition and usage of the asset.

In an exemplary implementation, the method 300 may include a Condition-Based Pressure Relief Device (PRD) model that may be utilized to dynamically adjust inspection and testing intervals based on real-time inspection results and pop test data. For instance, consider the PRD installed on a high-pressure vessel in a chemical processing plant. Traditionally, the PRD would undergo inspections and pop tests at fixed intervals, such as every 12 months, regardless of its actual condition. However, under the Condition-Based PRD model, if a recent pop test confirms the device is performing within acceptable safety thresholds and shows no signs of wear or degradation, the inspection interval can be extended to 18 or 24 months. Conversely, if the test reveals minor anomalies, the inspection frequency can be increased to prevent failure. This eliminates unnecessary inspections, ensures maintenance resources are prioritized for devices needing attention, and extends the lifecycle of the PRD while maintaining compliance with safety standards.

Continuing further, the method 300 includes the step of receiving one or more environmental factors from the ERP system. The environmental factors are selected from a group comprising temperature, humidity, external load, exposure to corrosive substances, and wherein the one or more environmental factors are incorporated in the determination of the PoF for each asset, enabling a more accurate and comprehensive risk assessment that accounts for external influences on asset performance.

While the aforementioned method 300 is described as being perform by the system 102, it may be appreciated by those skilled in the art that the method 300 may be suitably adapted for implementation using any other device, stored in computer-readable medium or performed by any other person. Further, it may be appreciated that the order in which the method 300 is described is not intended to be construed as a limitation, and any number of the described steps of the method 300 may be combined or otherwise performed in any order to implement the method 300 or an alternate method. Additionally, individual steps may be deleted from the method 300 without departing from the scope of the present disclosure described herein. Furthermore, the method 300 may be implemented in any suitable hardware, software, firmware, or a combination thereof that exists in the related art or that is later developed. The method 300 describes, without limitation, the implementation of the system 102. Those skilled in the art will understand that method 300 may be modified appropriately for implementation in various manners without departing from the scope of the present disclosure.

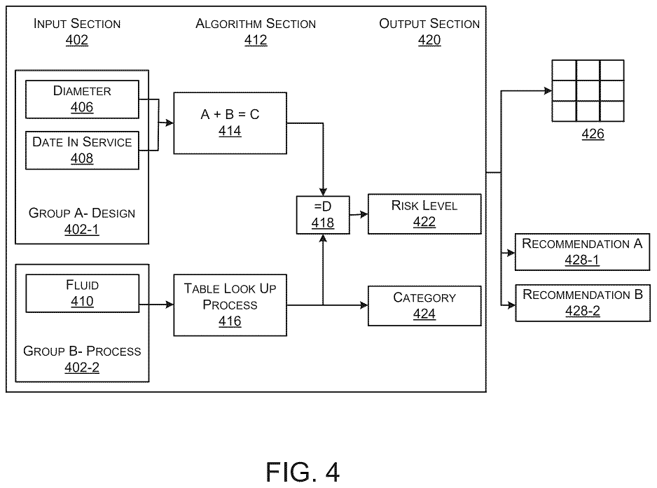

FIG. 4 illustrates a flowchart 400 of an exemplary implementation of a template using proposed method 300, according to embodiments of the present disclosure. The method 300 determines risk level and generates inspection recommendations based on these three sections input section at block 402, algorithm section at block 412, and output section at block 420. The process begins with input section at block 402, where data is categorized into two groups Group A at block 402-1 and Group B at block 402-2. The Group A at block 402-1, referred to as Design, includes parameters such as diameter at block 406 and date in service at block 408. The diameter represents the size specification of the asset, while date in Service indicates when the asset began operation. The parameter serves as a general input contributing to the asset's characteristics. The Group B at block 402-2, referred to as Process, includes fluid parameters at block 410, which represent type of fluid being handled and influence risk evaluation.

In algorithm section at block 412, parameters from Group A and Group B are processed at block 414. From Group A, parameters like diameter and date in service are used in a calculation represented by an equation A+B=C, which provides an intermediate result. Simultaneously, in Group B, the fluid parameter undergoes evaluation through a Table Look Up process at block 416. This lookup references predefined risk-related conditions or values, and outcome of the Table Look Up process at block 416 feeds into an additional equation at block 418 denoted as D, integrating results from the block 414 and the block 416 for further analysis.

Further outputs section at bock 420 produces two key results from additional equation at block 418. These two key results are risk level at block 422 and category at block 424. The risk level at block 422 reflects a measure of the asset's risk, derived from combined calculations performed in the algorithm section at block 412. The category at block 424 represents a classification of the asset's risk or condition, influenced by the Table Look Up results and intermediate computations. Both outputs from blocks 422 and 424 are further visually represented on a Matrix Plot 426, which maps the evaluated risk levels and categories. The matrix allows for easy identification of high-risk areas and supports prioritization of assets 106 requiring attention. Furthermore, based on the plotted results in the Matrix Plot at block 426, specific recommendations are generated. These include Recommendation A 428-1 and Recommendation B 428-2, which suggest actions to address the identified risks and prioritize maintenance or inspection tasks. The combination of inputs, algorithms, and outputs in this template provides a structured and systematic approach to risk assessment and management.

The present disclosure, hence, allows for a more efficient, adaptive, and precise system 102 and method 300 for asset management through the integration of advanced risk-based inspection (RBI) methodologies and real-time data-driven models. By utilizing frameworks 104 such as API RP 581, EN 16991, and condition-based models for Pressure Relief Devices (PRDs), the system 102 dynamically adjusts maintenance and inspection schedules based on asset performance, condition, and risk factors. This ensures that maintenance efforts are directed where they are most needed, reducing unnecessary inspections, minimizing costs, and optimizing resource utilization.

Industrial applications for this disclosure span multiple sectors, including hydrocarbons, chemicals, power generation, and manufacturing, where asset integrity, operational safety, and regulatory compliance are paramount. For instance, in a refinery setting, the system 102 can prioritize the inspection of essential assets such as pressure vessels and pipelines, ensuring safety while reducing downtime. By enhancing operational efficiency and ensuring compliance with international standards, the present disclosure provides a robust solution for industries aiming to maintain high performance, reliability, and safety in their asset management practices.

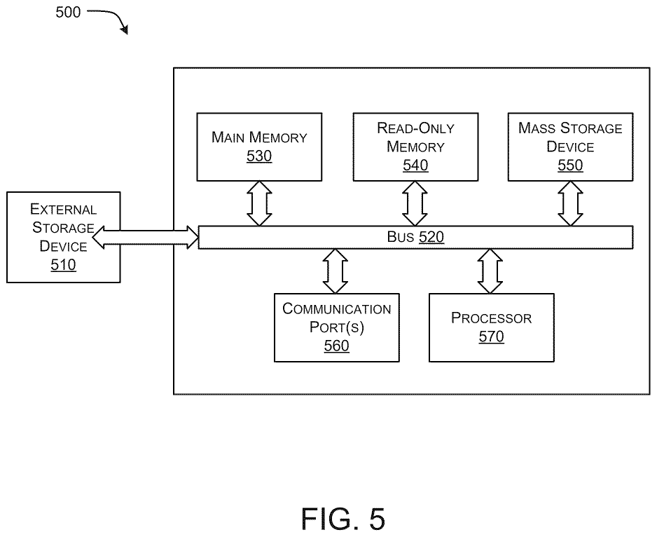

Referring to FIG. 5, the block diagram represents a computer system 500 that includes an external storage device 510, a bus 520, a main memory 530, a read only memory 540, a mass storage device 550, a communication port 560, and a processor 570. A person skilled in the art will appreciate that the computer system 500 may include more than one processor 570 and communication ports 560. The processor 570 may include various modules associated with embodiments of the present disclosure. The communication port 560 can be any of a Recommended Standard 232 port for use with a modem-based dialup connection, a 10/100 Ethernet port, a Gigabit or 10 Gigabit port using copper or fiber, a serial port, a parallel port, or other existing or future ports. The communication port 560 may be chosen depending on a network, such as a Local Area Network (LAN), a Wide Area Network (WAN), or any network to which computer system 500 connects.

In an embodiment, the memory 530 can be a RAM, or any other dynamic storage device commonly known in the art. The Read-Only Memory (ROM) 540 may be any static storage device(s) e.g., but not limited to, a Programmable Read-Only Memory (PROM) chip for storing static information. The mass storage 550 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus 520 communicatively couples the processor(s) 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 570 to the computer system 500.

In another embodiment, operator and administrative interfaces, e.g., a display, keyboard, and a cursor control device, may also be coupled to the bus 520 to support direct operator interaction with computer system 500. Other operator and administrative interfaces may be provided through network connections connected through communication port 560. In some embodiments, the external storage device 510 can be any kind of external hard-drives, floppy drives, Compact Disc Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 500 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

What is claimed is:

1. A method for implementing a framework for Risk-Based Inspection (RBI) methodologies, comprises:
receiving a set of parameters of one or more assets from an enterprise resource planning (ERP) system, wherein the received set of parameters comprises at least one of: asset specifications, historical inspection data, and real-time performance metrics;
determining probability of failure (PoF) for each asset, taking into consideration the received set of parameters, and considering one or more factors of each asset comprising condition, usage history, and environmental conditions;
evaluating consequence of failure (CoF) by assessing an interaction between the operational data and the determined PoF, and evaluating impact of failure using a fluid modeling technique such as Loss of Containment or Loss of Production approach;
calculating risk levels for each asset from the determined PoF and the evaluated CoF to quantify risk associated with each asset;
plotting the calculated risk levels on a risk prioritization matrix to visually represent and identify the high-risk assets, and correspondingly prioritize each asset for maintenance;
refining the PoF, using updated real-time data, such as real-time performance metrics and inspection results of each asset;
updating the risk levels and adjust prioritization of the one or more assets in the risk prioritization matrix based on the refined PoF; and
generating inspection recommendations and maintenance schedules based on the updated risk levels and the adjusted prioritization of the one or more assets.

2. The method of claim 1, wherein the set of parameters for each asset are extracted from master data stored in the ERP system, and wherein a SAP Business Technology Platform (BTP) is utilized to process and integrate the master data into the framework.

3. The method of claim 1, wherein the fluid modeling technique such as Loss of Containment or Loss of Production approach evaluates the CoF that complies with one or more predefined standards.

4. The method of claim 1, wherein the risk prioritization matrix is a two-dimensional matrix that maps the determined PoF and the evaluated CoF for each asset to identify the high-risk assets in predefined regions of the risk prioritization matrix for prioritization.

5. The method of claim 1, wherein the method further comprises:
calculating a degradation rate for each asset based on the historical inspection data, and the real-time performance metrics, wherein the degradation rate is utilized for adjusting the generated maintenance schedules and recommend inspection intervals.

6. The method of claim 1, wherein the method further comprises:
receiving one or more environmental factors from the ERP system, wherein the environmental factors are selected from a group comprising temperature, humidity, external load, and exposure to corrosive substances, and wherein the one or more environmental factors are incorporated in the determination of the PoF for each asset.

7. A system to implement a framework for Risk-Based Inspection (RBI) methodologies, the system comprising:
a processor; and
a memory coupled to the processor, wherein the memory comprises one or more processor-executable instructions that cause the processor to:
receive a set of parameters of one or more assets from an enterprise resource planning (ERP) system, wherein the received data comprise at least one of: asset specifications, historical inspection data, and real-time performance metrics;
determine probability of failure (PoF) for each asset taking into consideration the received set of parameters, and considering one or more factors of each asset comprising condition, usage history, and environmental conditions;
evaluate consequence of failure (CoF) upon assessing interaction between the operational data and the determined PoF, and evaluate impact of failure using a fluid modeling technique such as Loss of Containment or Loss of Production approach;
calculate risk levels for each asset from the determined PoF and the evaluated CoF to quantify risk associated with each asset;
plot the calculated risk levels on a risk prioritization matrix to visually represent and identify high-risk assets, and correspondingly prioritize each asset for maintenance;
refine the PoF, using updated real-time data, such as real-time performance metrics and inspection results of each asset;
update the risk levels and adjust the prioritization of the one or more assets in the risk prioritization matrix based on the refined PoF; and
generate inspection recommendations and maintenance schedules based on the updated risk levels and the adjusted prioritization of the one or more assets.

8. The system of claim 1, wherein the set of parameters for each asset are extracted from master data stored in the ERP system, and wherein a SAP Business Technology Platform (BTP) is utilized to process and integrate the master data into the framework.

9. The system of claim 1, wherein the fluid modeling technique such as Loss of Containment or Loss of Production approach, complies with one or more predefined standards.

10. The system of claim 1, wherein the risk prioritization matrix is a two-dimensional matrix that maps the determined PoF and evaluated CoF for each asset to identify the high-risk assets 106 in predefined regions of the risk prioritization matrix for prioritization.

11. The system of claim 1, wherein the processor is further configured to calculate a degradation rate for each asset based on the historical inspection data, and the real-time performance metrics, and wherein the degradation rate is used to adjust the generated maintenance schedules and recommend inspection intervals.

12. The system of claim 1, wherein the processor is further configured to:
receive one or more environmental factors from the ERP system, wherein the environmental factors are selected from a group comprising temperature, humidity, external load, exposure to corrosive substances, and wherein the one or more environmental factors are incorporated in the determination of the PoF for each asset.

13. A non-transitory computer-readable medium comprising processor-executable instructions that cause a processor to:
receive a set of parameters of one or more assets from an enterprise resource planning (ERP) system, wherein the received data comprise at least one of: asset specifications, historical inspection data, and real-time performance metrics;
determine probability of failure (PoF) for each asset taking into consideration the received set of parameters, and considering one or more factors of each asset comprising condition, usage history, and environmental conditions;
evaluate consequence of failure (CoF) upon assessing interaction between the operational data and the determined PoF, and evaluates impact of failure using a fluid modeling technique such as Loss of Containment or Loss of Production approach;
calculate risk levels for each asset from the determined PoF and the evaluated CoF to quantify risk associated with each asset;
plot the calculated risk levels on a risk prioritization matrix to visually represent and identify high-risk assets, and correspondingly prioritize each asset for maintenance;
refine the PoF, using updated real-time data, such as real-time performance metrics and inspection results of each asset;
update the risk levels and adjust the prioritization of the one or more assets in the risk prioritization matrix based on the refined PoF; and
generate inspection recommendations and maintenance schedules based on the updated risk levels and the adjusted prioritization of the one or more assets.
